(19) United States
(12) Patent Application Publication
(10) Pub. No.: US 2002/0046279 A1
(43) Pub. Date: Apr. 18, 2002

(54) Methods and systems for call processing utilizing a uniform resource locator

(76) Inventor: David Chung, San Pedro, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/852,136

(22) Filed: May 9, 2001

Related U.S. Application Data
(60) Provisional application No. 60/246,164, filed on Nov. 6, 2000.

(30) Foreign Application Priority Data
May 9, 2000 (KR) 2000-24557

(51) Int. Cl. G06F 15/16

(52) U.S. Cl. 709/227

(57) ABSTRACT

The present invention provides systems and methods for processing calls over a network using a web page. In one embodiment, a server receives a user call request generated by a user activating a web page call request control, which submits a uniform resource locator (URL) corresponding to a networked resource. Data for a first telephone number corresponding to the requested URL is downloaded to a client computer used to place the call request. A call client requests that a call connection be established between the user client computer and a communication terminal corresponding to the telephone number. The call connection is then established.

### PRIORITY CLAIM

This application claims the benefit of U.S. Provisional Application No. 60/246,164, filed Nov. 6, 2000, which is incorporated herein in its entirety.

### BACKGROUND OF THE INVENTION

1. Field of the Invention

The present invention relates to methods and systems of call processing, and in particular, to methods and systems of call processing over a network.

2. Description of the Related Art

The Internet has recently become very popular. The Internet system consists of a plurality of computers and a computer network connected through a communication link. The connected computers can exchange information using a variety of services, such as e-mail service, Gopher service, FTP (File Transfer Protocol) service, WWW service and so on. The WWW service allows web page information written in an HTML (Hypertext Markup Language) document to be transmitted from a server computer system, i.e., a web server, to a remote client system. A characteristic URL (Uniform Resource Locator) is given to each resource on the web, that is, a computer or web page. If a client system designates a URL of the corresponding web page and requests transmission of information in accordance with HTTP (Hypertext Transfer Protocol) in order to view a particular web page, the server system transmits the information corresponding to the web page in response to the request. If the web page information is received by the client system, the client system displays the received information on a monitor using a browser.

A variety of services are available over the Internet, such as cyber transaction services, including electronic commerce and auction services, cyber banking services, such as stock trading and banking services, cyber or distance learning education services, and the like. Web sites play an important role in providing such services, providing bridges connecting Internet users, such as cyber customers, and enterprises through the variety of services.

However, existing enterprise web sites mainly serve as one-way providers of media, such as advertisements for goods, services or enterprise information. During certain transactions, an Internet user may want to establish communication with someone associated with a website. For example, an Internet user who is surfing an enterprise's website may want to contact the enterprise's customer service center to obtain information. The requested information may relate to the enterprise itself, or the requested information may relate to goods or services offered by the enterprise. Typically, to request or obtain such information, the user has to consult with the enterprise's customer service center or other employee using e-mail or by placing a phone call after looking up or otherwise obtaining the telephone number of the enterprise. Disadvantageously, the use of e-mail is somewhat cumbersome for these purposes, as e-mail typically requires that inquiries be written or typed in rather than be expressed verbally. Additionally, because email communication is not conducted in real time, and is instead a series of one-way communications, requesting and receiving information is often a time-consuming process.

In the case where inquires are made using phone calls, often the user is surfing one medium, that is, a computer accessing the Internet, and another medium, that is, a telephone connected to a telephone system, is conventionally used to place the call. Further, when both phone service and Internet access is provided using the same dial-up phone line, the Internet connection needs to be cumbersomely disconnected before the call can be placed.

### SUMMARY OF THE INVENTION

It is an object of the present invention to provide methods and systems for processing calls over a network, and in particular to methods and systems for processing a call in a web page using a URL. In one embodiment, the method completely changes the design, including the client user interface appearance, of a call client by inputting another enterprise's URL on the same call client using a skin server, which stores and serves skin information for a variety of enterprises. The method further provides statistics and chargeable services based on various settlement or payment methods. In addition, one embodiment includes a billing system, and can enable the establishment of a call connection with a called party simply by clicking on a calling button in the web page to transmit the URL to the called party.

To accomplish the above object of the present invention, there is provided a method of processing a call in a web page of an enterprise, comprising the steps of a user requesting a call in the web page, downloading a call client and a customer file containing data of telephone numbers of the enterprise corresponding to a URL (Uniform Resource Locator) of the requested web page and a call client, the call client requesting a call connection to a telephone number provided in the customer file to establish communication between the user and a customer service center or department of the enterprise, and if a URL of another enterprise is input over the call client which has been already activated, moving to the enterprise site of another enterprise and changing the design of the call client.

According to another aspect of the present invention, there is provided a custom virtual call system for offering a call connection service which allows users to be directly connected to customer service centers or departments of enterprises in or using the web pages of the enterprises, in the case where the enterprises that are running their own home pages are subscribers to the Internet, the system including a custom URL server for receiving the URL of the corresponding web page if the user requests a call connection in the web page of the enterprise, providing the customer file containing the telephone number and a call client stores to the user and transferring the user information input by the user through the call client to the enterprise, a skin server for accessing the corresponding enterprise if a URL of another enterprise is input over the same call client, and changing the design of the call client in a fashion customized to the corresponding enterprise, and call connecting means for connecting a call to the customer service center or department of the enterprise through a VoIP (Voice over Internet Protocol) technique if the user request call connection through the call client.

According to yet another aspect of the present invention a method is provided for processing a call using a web page displayed on a user client computer, including receiving at a server system a user call request generated at least partly in response a user activating a web page call request control which causes the submission to the server system of a uniform resource locator (URL) corresponding to a networked resource, downloading to the client computer data for a first telephone number corresponding to the URL, requesting, using a call client, that a call connection be established between the user client computer and a communication terminal corresponding to the telephone number, and completing the requested call connection.

One embodiment of the present invention is a method of establishing a call using a web page displayed on a user system, comprising receiving from the user system a user call request, including a uniform resource locator (URL) corresponding to a networked resource, initiated by a user activating a call request function provided on a web page associated with a first enterprise, transferring to the client system a call client at least partly in response to the user call request, transferring to the client system, at least partly in response to the user call request, data for a plurality of telephone numbers, including a plurality of department names associated with corresponding telephone numbers, requesting, at least partly in response to the user selecting at least one of the department names, that a call connection be established between the user client computer and the department whose name was selected, and establishing the requested call connection.

One aspect of the present invention is a call processing system, the system comprising, a first server configured to receive a uniform resource locator (URL), sent by a user system, wherein the URL corresponds to a network resource of a first enterprise, the URL sent at least partly in response to a user call request established as a result of a user activating a web page call request control, the server further configured to transfer to the user system a telephone number corresponding to the first enterprise in response to receiving the URL, a call client configured to be executed by the user system and to request a call connection to a telephone number provided by the first server, a skin server configured to provide information for customizing the call client in accordance with the characteristics of the enterprise, and a call connecting system configured to connect a call to an enterprise communication device corresponding to the telephone number, the call connecting system including a Voice over Internet Protocol gateway.

Still another aspect of the present invention is a method of processing a call via a web page of an enterprise, comprising the steps of receiving a user call request, including a URL via the web page, downloading a call client and a customer file containing data for a plurality of telephone numbers of a first enterprise corresponding to the URL, requesting a call connection via the call client to a first telephone number contained within the customer file to establish communication between the user and an enterprise customer service center corresponding to the first telephone number, and if a URL of a second enterprise is input over the call client, accessing the enterprise site of the second enterprise and changing the design of the call client.

### BRIEF DESCRIPTION OF THE DRAWINGS

The above object and advantages of the present invention will become more apparent by describing in detail a preferred embodiment thereof with reference to the attached drawings in which:

FIG. 1 is a schematic diagram illustrating a custom virtual call system and an Internet network according to the present invention;

FIGS. 2A-2B depict a flow chart illustrating the process steps of directly connecting a call to a customer service center or department of an enterprise in the web page of the enterprise, according to the present invention;

FIG. 3 is a schematic block diagram illustrating the flow of data and the flow of a call; and

FIG. 4 illustrates an example of a screen showing the selection of a telephone number on a call client according to the present invention.

### DETAILED DESCRIPTION OF THE PREFERRED EMBODIMENT

A preferred embodiment of the present invention will now be described in detail with reference to the accompanying drawings.

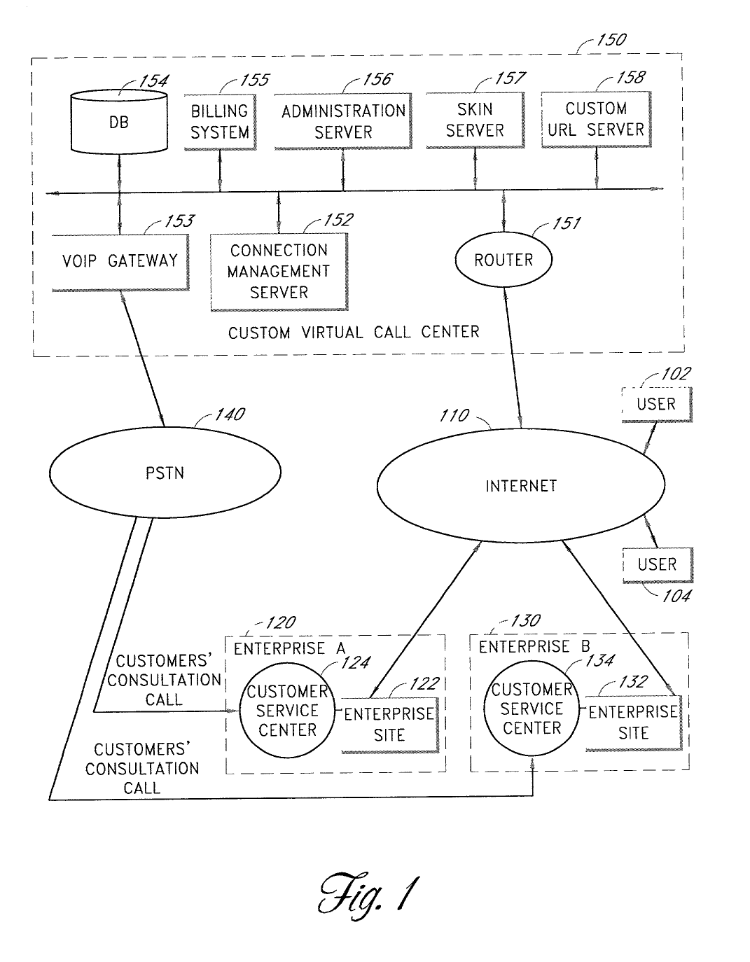

FIG. 1 is a schematic diagram illustrating a custom virtual call system and an Internet network according to the present invention. Referring to FIG. 1, a custom virtual call system 150 according to the present invention includes a router 151, a connection management server (CMS) 152, a VoIP (Voice over Internet Protocol) gateway 153, a database (DB) 154, a billing system 155, an administration server 156, a skin server 157 and a custom URL server 158. The custom virtual call system 150 is connected to the Internet 110 through the router 151 and is connected to a PSTN (Public Switched Telephone Network) 140 through the VoIP gateway 153.

The router 151 of the custom virtual call system 150 provides a routing function for access to the Internet. The VoIP gateway 153 provides an access path between a general telephone client and a custom or customizable virtual call system client through the PSTN 140. As discussed below, the customizable virtual call systems enables a call client to have a skin that changeably corresponds to the enterprise site being accesses. The CMS 152 manages the connection information of clients. The DB 154 stores a variety of data, such as user data, and the billing system 155 performs user authentication and accounting. The administration server 156 performs administration of the overall system.

The skin server 157 provides enterprise information, so that a call client is established so as to be in conformity with characteristics of the enterprise. As discussed below, each enterprise can have corresponding customer files used to establish the call client in conformity with the enterprise's characteristics. The custom URL server 158 stores customer files, i.e., Virtual call center (VCC) files. The customer files contain the information for customers' URLs and telephone numbers. Thus, the customer files act as a virtual telephone number directory. The custom URL server 158 transmits the corresponding customer file to a user when a URL corresponding to a web page for which the user requests a call, is received. In this case, the virtual telephone number directory, transmitted via the VCC file, contains names and telephone numbers of the enterprise's departments, based on the enterprise's organization structure, so that the user can reach his/her desired department simply by one-time clicking on a button or other icon linked to the call client.

The virtual telephone number directory can be prepared by directly inputting telephone numbers using the administrative tool by a person involved with or responsible for the enterprise's customer support operations. In addition, the virtual number directory contents can be modified to correspond to changes in the enterprise organization and telephone numbers. Alternatively, the virtual telephone number directory may be provided according to the customer's option. A call connection may be directly established through the representative telephone number of the call center agent of the enterprise, without selecting a separate telephone number. Such an option may be adjusted by an authorized person, such as the enterprise staff in charge of customer consultations performed over a web page. In order to ensure a user is authorized to modify the VCC file contents and virtual telephone directory, a predetermined authentication step is performed.

An Enterprise A 120 has an enterprise site 122 for running Enterprise A's home page over the Internet and for running a customer service center 124 for handling customers' consultation calls. The respective server functions may be embodied independently, or may be integrated into one server. Also, an Enterprise B 130 has an enterprise site 132 for running Enterprise B's home page over the Internet, and for running a customer service center 134 for handling customers' consultation calls. The Enterprise A 120 and the Enterprise B 130 are subscribers to the custom virtual call system 150 according to the present invention and can use the custom virtual call service according to the present invention.

A web browser is run on each of the user computers (hereinafter, simply referred to as users) 102 and 104 and web pages of enterprise sites or other various sites can be viewed while the users are surfing the Internet. According to the present invention, while the users 102 and 104 visit or access the Enterprise A site 122 and the Enterprise B site 132, they not only can directly communicate with the consultant or customer support department of the corresponding enterprise on the Internet through a call client provided when accessing the corresponding enterprise site, but can also transfer or provide customer information to the consultant.

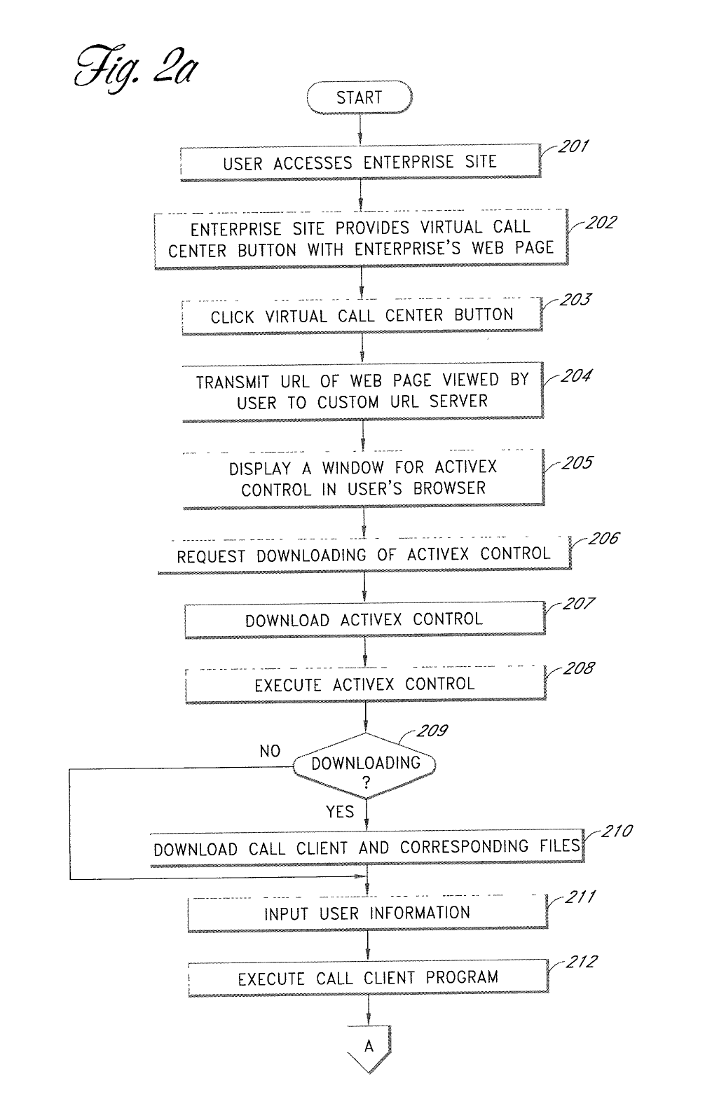

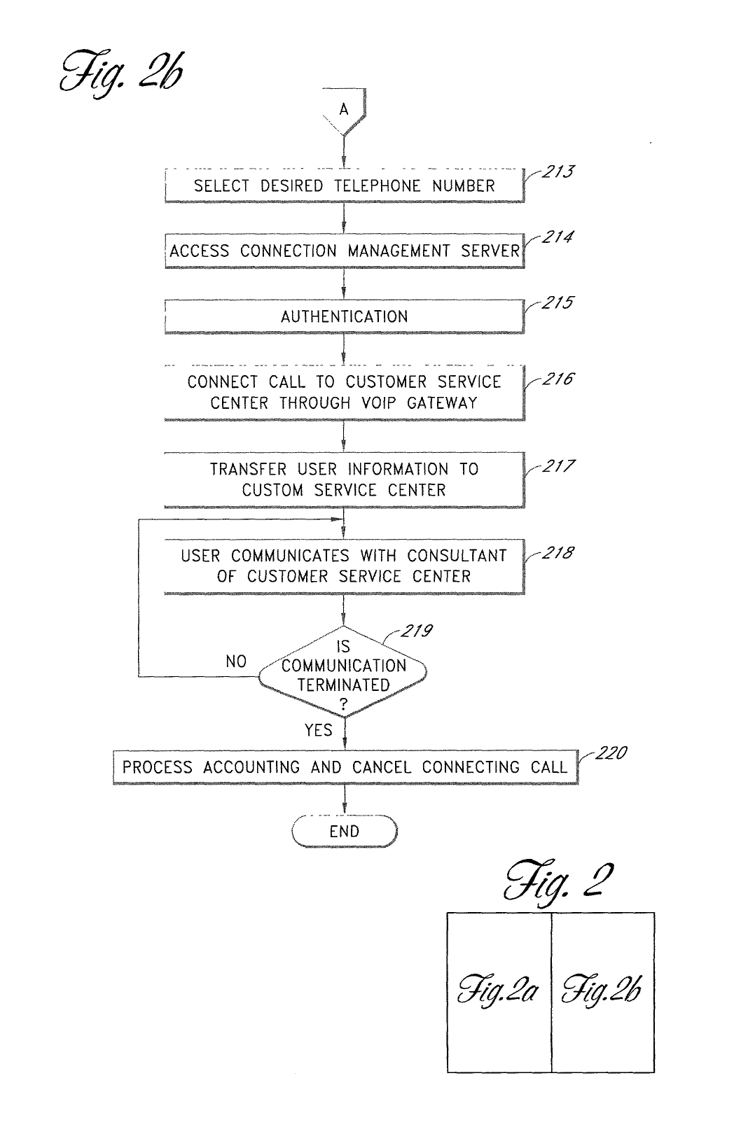

FIGS. 2A-2B depict a flowchart illustrating the process steps of directly connecting a call to a customer service center or department of an enterprise using an enterprise web page, according to the present invention.

If a user accesses a site of an enterprise subscribed to the service according to the present invention, while surfing the Internet, the enterprise site provides a “call button” on an appropriate web page that allows the user to use a virtual call center, such as the call center previously described, with the web page of the enterprise (steps 201 and 202). If the user wants to communicate with a consultant of the enterprise while viewing the web page, the virtual call center button is directly clicked on or otherwise activated by the user without a separate dialing step. Thus, for example, the user does not have to manually enter the phone number digits.

If the virtual call center button is clicked on or otherwise activated, the URL of the web page viewed by the user is transmitted to the custom URL server 158 of the custom virtual call system (step 204). The custom virtual call system 150 can use an embedded program, e.g., ActiveX or Java, stored on the URL web server 158. Here, the ActiveX program dynamically updates static conventional WWW pages. Client-side techniques include utilizing an ActiveX control for downloading and executing a program from the server, and an interactive object which is the basis of the ActiveX control and exists in a web document. The release of new version of client applications can be automatically controlled through the ActiveX control, so that new releases are conveniently performed, as is well know in the art. Server-side techniques include ISAPI (Internet Server Application Program Interface), which is an API (Application Program Interface) for the WWW server, a server program implemented using ActiveX server script, and ActiveX server controls for implementing ActiveX controls in the server. ActiveX is a set of technologies that enable software components to interact with one another in a networked environment, regardless of the language in which the components were created. An ActiveX control is a user interface element created using ActiveX technology. Thus, ActiveX controls are software components that can add specialized functionality to Web sites and documents, desktop applications, and development tools.

A window for loading an embedded program from the custom URL server 158 is then displayed on a user's browser and the user's browser requests downloading of the embedded program (steps 205 and 206) from the URL server 158. Accordingly, the embedded program having parameters of a VCC file, a URL for a call client and appropriate call client versions are downloaded (step 207).

Next, the ActiveX control is executed (step 208). In detail, the embedded program is executed with the previously discussed parameters, and the embedded program checks whether a call client is installed on the user's computer or not. If the call client is installed, the version information thereof is checked to determine if a later version of the call client is available for download. Then, the embedded program checks whether a VCC file for the corresponding URL is installed or not. If installed, it is determined by the embedded program whether the call client and the VCC file are to be downloaded from the URL server 158 or not (step 209). Here, the VCC file for a URL corresponding to an enterprise client includes a virtual telephone number directory having names and telephone numbers of various departments based on the organization structure of the enterprise client. By using the virtual telephone number directory, a user can be connected to his/her desired department by activating or clicking just once on the intended call recipient's name or number as discussed below.

If downloading is necessary, the call client and the corresponding files are downloaded, user information is input, as described in greater detail below, and then a call client program is executed (steps 210, 211 and 212). When the call client program is executed, a screen for selection of a telephone number for connecting a user's call to the user's desired department is displayed. The user selects, by clicking on the name of his/her desired department from the selection screen, so that a call connection process establishing a call connection to the pertinent department is automatically executed (step 213).

As described above, the embedded program extracts from the VCC file the information necessary for a call client program. The information includes the client design skin information, which is customized to each enterprise client, enterprise information, user information and so on. The embedded program stores the extracted information on the user's computer and then executes the call client program. The call client program receives needed information from the user. For example the call client program receives a user selected telephone number and the like, in accordance with requests for user information, extracted by the embedded program, and determines the design skin of its call client. Thus, the call client does not take a fixed form, but can be implemented in various forms so as to be adapted to the characteristics, such as the enterprise design or skins, telephone numbers, and the like of the enterprise client. Advertisement content may also be activated, that is enable for display, along with the call client. Also, if a URL of another enterprise is input at the already activated call client, the corresponding enterprise site is accessed and the call client design is appropriately customized to the enterprise.

Then, the call client accesses the CMS 152 and transfers the input user information thereto, and the CMS 152 requests user authentication to the billing system 155 using the user information received from the call client (steps 214 and 215). During the user authentication, it is verified whether or not the user who requesting access is registered or qualified to use the VoIP gateway 153. The CMS 152 authenticates the call client using the information verified by the billing system 155. The authenticated call client connects a call to the customer service center 124 or 134 with the telephone number corresponding to the URL through the VoIP gateway 153 and the PSTN 140.

Subsequently, the information input by the user is transferred to the customer service center through an instant messenger for user information transfer. If the user is a new or first-time customer, or if there is any change in the user information, the corresponding data is stored in the database 154 (step 217). If a call is connected, the user communicates with the consultant of the customer service center. Once the communication is terminated, the corresponding accounting information is processed and the connection is canceled (steps 218 through 220). In other words, when a call is finished, a call detailed record (CDR) and accounting related information are generated by the VoIP gateway 153 and are then stored in the database of the billing system 155.

Then, the user can extract or use statistics related to the call connection using a web-based billing system. The enterprise consultant can retrieve accounting information from the billing system 155 using a conventional customer management tool. The administrator can process account details, statistics or setup options and settings using an administration tool. Also, a consultation history, that is, the information indicating from which URL the VCC has been used, can be identified using the consultant's personal computer and a given tool, such as the administration tool. Thus, the enterprise administrator is informed as to which URLs are most frequently accessed by users.

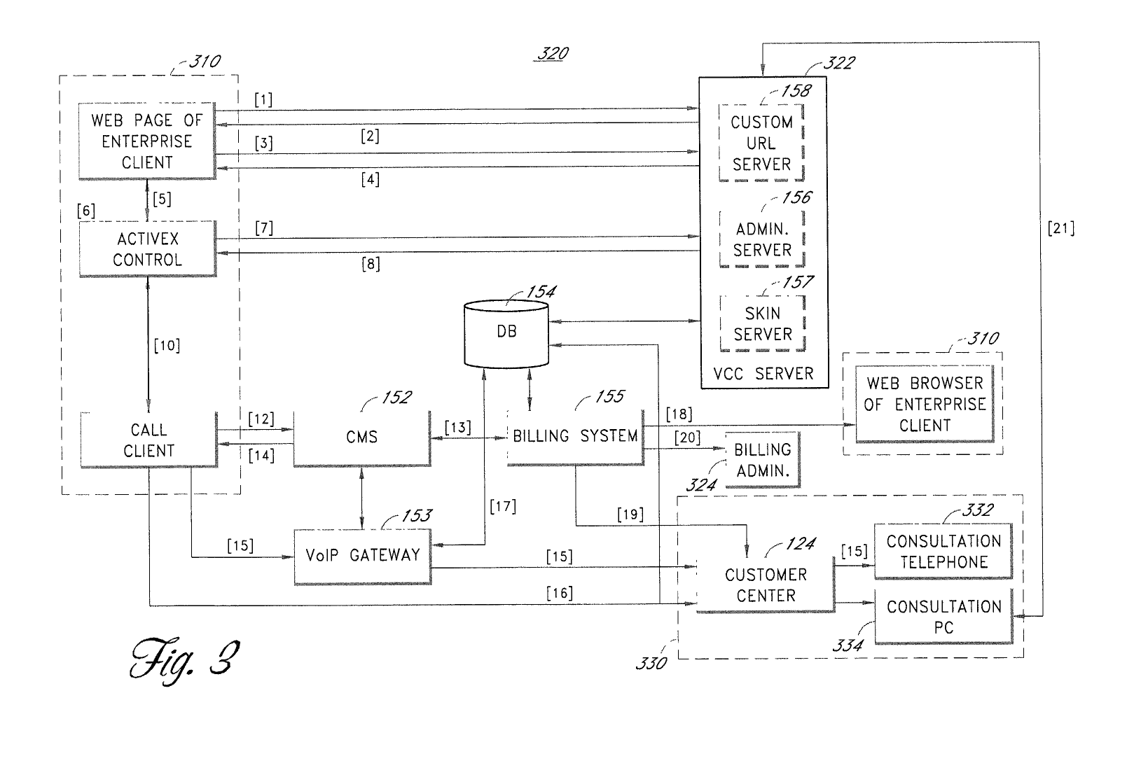

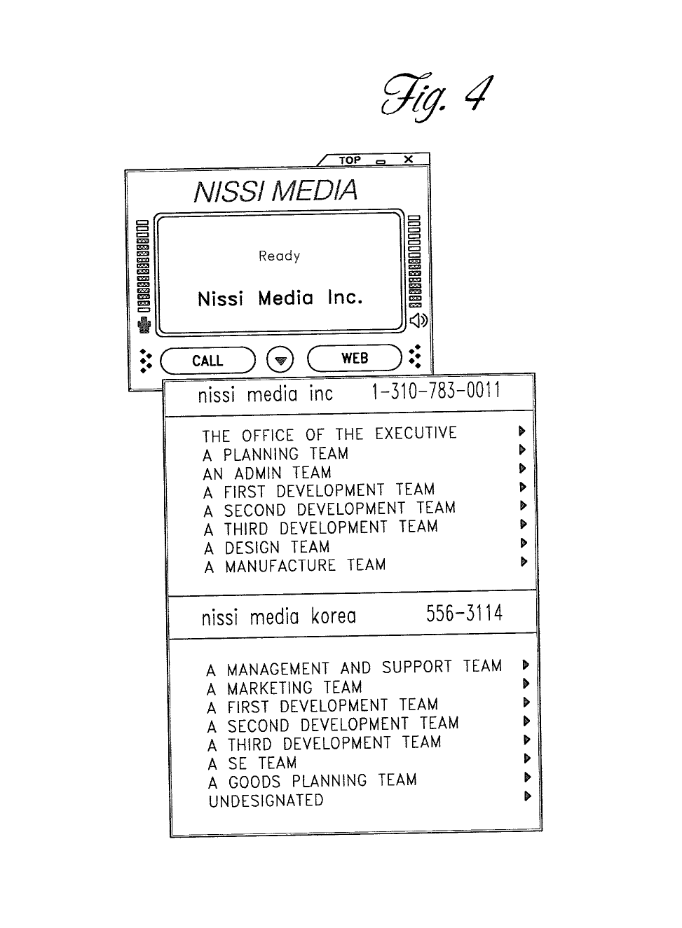

FIG. 3 illustrates a data and call flow according to the present invention. Referring to FIG. 3, largely divided into a user part 310, an enterprise part 330 and a custom virtual call system part 320, the flow of data between these parts is indicated by solid lines and the flow of a call is indicated by dotted lines in the order of operations [1] through [21]. In the user part 310, the procedure generally executed on the user's computer is conceptually illustrated, and a custom URL server 158, an administration server 156 and a skin server 157 may be implemented into a single computer (server) 322.

Referring to FIG. 3, in step [1], a user clicks on a button in a web page to transfer a URL for the web page of an enterprise client to the custom URL server 158. In step [2], a window for loading an embedded program, such as ActiveX or Java, received from the server, is displayed on the user's browser. In step [3], the user's browser requests downloading of the embedded program. In step [4], the embedded program having parameters of a customer file (VCC file), a URL for the call client and versions are downloaded.

In step [5], the embedded program is executed with the given parameters. In step [6], it is checked whether the call client and the VCC file are to be downloaded or not. In step [7], downloading of the necessary files is requested. In step [8], the necessary files are downloaded, and in step [9], the embedded program extracts from the VCC file the information necessary for the call client and stores the same locally. In step [10], the embedded program executes the call client. In step [11], the call client program receives from the user the necessary information in accordance with the request of inputting the user information extracted by the embedded program and determines the design skin of its call client.

In step [12], the call client program accesses the CMS 152 and transfers the input user information thereto, and the CMS 152 requests user authentication from the billing system 155 using the user information received from the call client program. That is to say, it is verified whether or not the client is a registered user or an authenticated user of the VoIP gateway 153. In step [14], the CMS 152 authenticates the call client program using the information verified by the billing system 155. In step [15], the authenticated call client program connects a call to a consultation telephone 332 with the telephone number corresponding to the URL through the VoIP gateway 153. In step [16], the information input by the user is transferred to the customer service center 320. In the case where the user is attempting to establish a call connection for the first time, the data indicating that the user is a first-contact customer is stored in the corresponding DB 154.

In step [17], when the call is finished, CDR and accounting related information are generated by the VoIP gateway 153 to then be stored in the DB 154. In step [18], the accounting information can be viewed using a web browser 310. In step [19], the customer service center 124 can retrieve the accounting information. In step [20], a billing administrator 324 can process account details, statistics or setup. In step [21], consultation history, that is, the information from which URL the VCC has been used can be identified using a consultation PC 334.

As described above, according to the present invention, a call can be directly connected to the customer service center of an enterprise in the web page. Here, user information is provided in cooperation with a separately provided instant messenger for customer information transfer, and an existing customer information transfer browser used by an enterprise client, thereby allowing marketing to be preformed through management of the user information. In particular, in the case where access to another enterprise is intended on a call client window, the access is allowed by simply inputting the URL of the corresponding enterprise. Also, services customized to each enterprise client can be rendered in view of the characteristic call client design of an enterprise, the management of customer information, advertisement types and the like.

Also, the present invention provides a billing solution so that a variety of services using various settlement means such as prepaid cards, postpaid cards or credit cards can be offered. Further, a virtual telephone number directory of an enterprise client is conveniently used such that a user can directly communicate with a person in charge of consultation in the user's desired department. In other words, if the user selects his/her desired department from the virtual telephone number directory of the call client, the user can directly access a person in charge of consultation in the desired department, without passing through an IVR (Interactive Voice Response) unit. Although this invention has been described in terms of certain preferred embodiments, other embodiments that are apparent to those of ordinary skill in the art are also within the scope of this invention. Accordingly, the scope of the present invention is intended to be defined only by reference to the appended claims.

What is claimed is:

1. A method of processing a call using a web page displayed on a user client computer, comprising:
receiving at a server system a user call request, including a uniform resource locator (URL) corresponding to a networked resource, generated at least partly in response a user activating a web page call request control;
downloading to the client computer data for a first telephone number corresponding to the URL;
requesting, using a call client, that a call connection be established between the user client computer and a communication terminal corresponding to the telephone number; and
establishing the requested call connection.

2. The method as defined in claim 1, wherein the first telephone number is that of a call service center of an enterprise associated with the web page.

3. The method as defined in claim 1, wherein the call connection is established via a VoIP (Voice over Internet Protocol) gateway.

4. The method as defined in claim 3, further comprising verifying that the user is qualified to access the VoIP gateway.

5. The method as defined in claim 1, wherein the data for the first telephone number is downloaded as part of a file containing data for a plurality of other telephone numbers.

6. The method as defined in claim 1, wherein the call client is downloaded from the server system to the user client computer at least partly in response to determining that the call client is not installed on the user client computer.

7. The method as defined in claim 1, wherein the data for the first telephone number is downloaded at least partly in response to determining that a file containing the data for the first telephone number is not already present on the user client computer.

8. The method as defined in claim 1, wherein the call connection request is made in response to the user selecting a name associated with the first telephone number.

9. The method as defined in claim 1, further comprising downloading call client skin information corresponding to an enterprise associated with the web page, wherein the skin information is used to customize the call client.

10. The method as defined in claim 1, wherein the networked resource is a web page.

11. The method according to claim 1, further comprising transferring user information provided by the user to a customer service center using an instant messenger.

12. The method as defined in claim 1, further comprising:
receiving at the server system a second user call request generated by the user activating a second web page call request control which submits a uniform resource locator (URL) corresponding to a second networked resource; and
downloading call client skin information corresponding to an enterprise associated with the second web page.

13. A method of establishing a call using a web page displayed on a user system, comprising:
receiving from the user system a user call request, including a uniform resource locator (URL) corresponding to a networked resource, initiated by a user activating a call request function provided on a web page associated with a first enterprise;
transferring to the client system a call client at least partly in response to the user call request;
transferring to the client system data for a plurality of telephone numbers, including a plurality of department names associated with corresponding telephone numbers;
requesting, at least partly in response to the user selecting at least one of the department names, that a call connection be established between the user client computer and the department whose name was selected; and
completing the requested call connection.

14. The method as defined in claim 13, further comprising generating accounting information for the call connection.

15. The method as defined in claim 13, further comprising generating a detailed call record upon the call connection being ended.

16. The method as defined in claim 13, further comprising determining an amount of calls initiated using the URL.

17. The method as defined in claim 13, further comprising downloading an embedded program to the client system, the embedded program having as parameters a customer file and a URL for the call client.

18. The method as defined in claim 13, further comprising transferring to the client system skin data corresponding to the enterprise.

19. A call processing system, the system comprising:
a first server configured to receive a uniform resource locator (URL) sent by a user system, wherein the URL corresponds to a network resource of a first enterprise, the URL sent at least partly in response to a user call request established as a result of a user activating a web page call request control, the server further configured to transfer to the user system a telephone number corresponding to the first enterprise in response to receiving the URL;
a call client configured to be executed by the user system and to request a call connection to a telephone number provided by the first server;
a skin server configured to provide information for customizing the call client in accordance with characteristics of the enterprise; and
a call connecting system configured to connect a call to an enterprise communication device corresponding to the telephone number, the call connecting system including a Voice over Internet Protocol gateway.

20. The call processing system as defined in claim 19, wherein the call connecting system further comprises a connection management server configured to manage the call connection, and a billing system configured to generate call accounting information.

21. The call processing system as defined in claim 19, further comprising an administration server configured to administer the call processing system.

22. The call processing system as defined in claim 19, wherein the first server and the skin server are included in the same server system.

23. A method of processing a call via a web page of an enterprise, comprising the steps of:
receiving a user call request via the web page, the request including a URL;
downloading a call client and a customer file containing data for a plurality of telephone numbers of a first enterprise corresponding to the URL;
requesting a call connection via the call client to a first telephone number contained within the customer file to establish communication between the user and an enterprise customer service center corresponding to the first telephone number; and
if a URL of a second enterprise is input over the call client, accessing the enterprise site of the second enterprise and changing the design of the call client.

24. The method according to claim 23, further comprising transferring information input by the user to the customer service center using one of an instant messenger and a customer information transfer browser.

25. The method according to claim 23, wherein the customer file includes a virtual telephone number directory containing names and telephone numbers of an enterprise client.
